(19) United States
(12) Patent Application Publication
(10) Pub. No.: US 2026/0353418 A1
(43) Pub. Date: Nov. 5, 2026

(54) RECEIVING CHANNEL OCCUPANCY TIME (COT) STRUCTURE AT USER EQUIPMENT (UE)

(71) Applicant: Lenovo (Singapore) Pte. Ltd., Singapore (SG)

(72) Inventors: Karthikeyan GANESAN, Nauheim (DE); Alexander Johann Maria Golitschek Edler von Elbwart, Darmstadt (DE)

(21) Appl. No.: 19/102,790

(22) PCT Filed: Aug. 11, 2023
(86) PCT No.: PCT/IB2023/058152

§ 371 Date: Feb. 10, 2025

Related U.S. Application Data
(60) Provisional application No. 63/397,282, filed on Aug. 11, 2022.

(51) Int. Cl. H04W 72/40; H04W 74/00; H04W 74/0808

(52) U.S. Cl. CPC H04W 72/40; H04W 74/002; H04W 74/0808

(57) ABSTRACT

Various aspects of the present disclosure relate to communications between UEs over a sidelink in an unlicensed spectrum. In some embodiments, a UE shares an indication of a COT structure to a set of UEs that identifies a modified or overridden slot structure to be used for communication between the UEs. Receiver UEs can decode contiguous transmission upon receiving the indication of the COT structure. For example, a receiver UE can decode the contiguous transmission after receiving the COT structure indication and/or not decode the transmission in the absence of the indication of the COT structure.

### CROSS-REFERENCE TO RELATED APPLICATIONS

This application claims priority to U.S. Provisional Patent Application No. 63/397,282, filed on Aug. 11, 2022, entitled RECEIVING CHANNEL OCCUPANCY TIME (COT) STRUCTURE AT USER EQUIPMENT (UE), which is hereby incorporated by reference in its entirety.

### TECHNICAL FIELD

The present disclosure relates to wireless communications, and more specifically to sidelink communications between user equipment (UEs).

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In some cases, UEs communicate with one another in an unlicensed spectrum of a wireless communications system over a sidelink. The UEs can access one or more channel occupancy times (COTs) over the sidelink when establishing communication with other UEs.

### SUMMARY

The present disclosure relates to methods, apparatuses, and systems that support communications between UEs over a sidelink in an unlicensed spectrum. For example, a UE shares an indication of a COT structure to a set of UEs that identifies a modified or overridden slot structure to be used for communication between the UEs. The slot structure can include symbols that override gap symbols and feedback symbols and/or include extended symbols, to enable contiguous transmission between the UEs over the sidelink.

The set of UEs, acting as receiver UEs, can decode contiguous transmission upon receiving the indication of the COT structure. For example, a receiver UE can decode the contiguous transmission after receiving the COT structure indication and/or not decode the transmission in the absence of the indication of the COT structure.

Some implementations of the method and apparatuses described herein may further include a UE comprising a processor and a memory coupled with the processor, the processor configured to receive, from a UE over a sidelink, an indication of a channel occupancy time (COT) structure for a contiguous transmission over the sidelink and detect the contiguous transmission from the UE based on the received indication of the COT structure.

In some implementations of the method and apparatuses described herein, the indication of the COT structure includes an indication of a location of an extended cyclic prefix (CP-Ext) symbol or a Physical Sidelink Feedback Channel (PSFCH) symbol in the COT structure.

In some implementations of the method and apparatuses described herein, the contiguous transmission from the UE includes a contiguous Physical Sidelink Shared Channel (PSSCH) transmission in a gap symbol of the COT structure.

In some implementations of the method and apparatuses described herein, the contiguous transmission includes a PSSCH transmission, the processor is further configured to decode extra code bits in a gap symbol, a PSFCH symbol or an automatic gain control (AGC) symbol of the PSSCH transmission.

In some implementations of the method and apparatuses described herein, the processor is further configured to detect the indication of the COT structure and determine a reference starting slot from the detected COT structure.

In some implementations of the method and apparatuses described herein, the sidelink is part of an unlicensed spectrum.

In some implementations of the method and apparatuses described herein, the contiguous transmission over the sidelink includes transmitting sidelink control information (SCI) or sidelink data over two or more slots contiguous in a time domain.

In some implementations of the method and apparatuses described herein, the UE receives the indication of the COT structure during a first transmission of the COT, during a middle period of the COT, or along with reception of a COT sharing indicator.

In some implementations of the method and apparatuses described herein, the indication of the COT structure includes a bitmap configuration of symbols that override PSFCH symbols and guard symbols within slots of the slot structure of the sidelink with PSSCH symbols.

Some implementations of the method and apparatuses described herein may further include a method performed by a UE, comprising receiving, from a UE over a sidelink, an indication of a COT structure for a contiguous transmission over the sidelink, and detecting the contiguous transmission from the UE based on the received indication of the COT structure.

In some implementations of the method and apparatuses described herein, the indication of the COT structure includes an indication of a location of a CP-Ext symbol or a PSFCH symbol in the COT structure.

In some implementations of the method and apparatuses described herein, the contiguous transmission from the UE includes a contiguous PSSCH transmission in a gap symbol of the COT structure.

In some implementations of the method and apparatuses described herein, the contiguous transmission includes a PSSCH transmission, the processor is further configured to decode extra code bits in a gap symbol, a PSFCH symbol or an AGC symbol of the PSSCH transmission.

In some implementations of the method and apparatuses described herein, the processor is further configured to determine a reference starting slot from the detected COT structure.

In some implementations of the method and apparatuses described herein, the sidelink is part of an unlicensed spectrum.

In some implementations of the method and apparatuses described herein, the contiguous transmission over the sidelink includes transmitting SCI or sidelink data over two or more slots contiguous in a time domain.

In some implementations of the method and apparatuses described herein, the UE receives the indication of the COT structure during a first transmission of the COT, during a middle period of the COT, or along with reception of a COT sharing indicator.

In some implementations of the method and apparatuses described herein, the indication of the COT structure includes a bitmap configuration of symbols that override PSFCH symbols and guard symbols within slots of the slot structure of the sidelink with PSSCH symbols.

Some implementations of the method and apparatuses described herein may further include a UE comprising a processor and a memory coupled with the processor, the processor configured to determine whether an indication of a channel occupancy time (COT) structure for a contiguous transmission has been received from a transmitter UE over a sidelink and, upon determining that the indication of the COT structure has been received, decode the contiguous transmission.

In some implementations of the method and apparatuses described herein, when the contiguous transmission includes a PSSCH transmission, the processor is further configured to determine that the indication of the COT structure has not been received and not decode extra code bits in a gap symbol, a PSFCH symbol or an automatic gain control (AGC) symbol of the PSSCH transmission.

Some implementations of the method and apparatuses described herein may further include a method performed by a UE, comprising determining whether an indication of a channel occupancy time (COT) structure for a contiguous transmission has been received from a transmitter UE over a sidelink, and, upon determining that the indication of the COT structure has been received, decoding the contiguous transmission.

In some implementations of the method and apparatuses described herein, when the contiguous transmission includes a PSSCH transmission, the method further comprises determining that the indication of the COT structure has not been received and not decoding extra code bits in a gap symbol, a PSFCH symbol or an automatic gain control (AGC) symbol of the PSSCH transmission.

### BRIEF DESCRIPTION OF THE DRAWINGS

FIG. 1 illustrates an example of a wireless communications system that supports COT structure sharing between UEs in accordance with aspects of the present disclosure.

FIG. 2 illustrates an example of a diagram that supports sidelink communication between UEs in an unlicensed spectrum accordance with aspects of the present disclosure.

FIG. 3 illustrates an example of a diagram that supports multi-slot contiguous transmission between UEs in accordance with aspects of the present disclosure.

FIG. 4 illustrates an example of a diagram that supports a slot structure having a dedicated CP-Ext symbol in accordance with aspects of the present disclosure.

FIG. 5 illustrates an example of a diagram that supports sidelink slots in a resource pool in accordance with aspects of the present disclosure.

FIG. 6 illustrates an example of a diagram that supports a slot structure having a repeated transmission symbol in accordance with aspects of the present disclosure.

FIG. 7 illustrates an example of a block diagram of a device that supports COT structure sharing between UEs in accordance with aspects of the present disclosure.

FIG. 8 illustrates a flowchart of a method that supports COT structure sharing between UEs in accordance with aspects of the present disclosure.

FIG. 9 illustrates a flowchart of a method that supports COT structure detection by a receiver UE in accordance with aspects of the present disclosure.

### DETAILED DESCRIPTION

When utilizing a sidelink for communications in an unlicensed spectrum, a UE should perform contiguous transmission (e.g., contiguous bursts) until an end of its channel occupancy to retain the channel. Because the spectrum is unlicensed, other UEs can take over occupancy of the channel when gaps arise, and the UE can lose its occupancy of a COT.

To perform contiguous transmission, the UE can override or otherwise modify the pre-defined slot structure of the COT (e.g., gaps in the slot structure), which is known to other UEs. Thus, the UE can inform or share information to the other UEs that indicates how the UE is going to utilize the slot structure for contiguous transmission. For example, the UE can share an indication of the slot structure to a set of UEs. The indication can include symbols that override gap symbols and feedback symbols and/or include extended symbols, in order to remove or reduce gaps in the slot structure.

Receiver UEs can decode contiguous transmission upon receiving the indication of the COT structure. For example, a receiver UE can decode the contiguous transmission after receiving the COT structure indication and/or not decode the transmission in the absence of the indication of the COT structure.

Thus, the UE can communicate over a sidelink in an unlicensed spectrum without potentially losing occupancy of a COT due to gaps in the slot structure of the sidelink, providing reliable communications between UEs, among other benefits.

Aspects of the present disclosure are described in the context of a wireless communications system. Aspects of the present disclosure are further illustrated and described with reference to device diagrams and flowcharts.

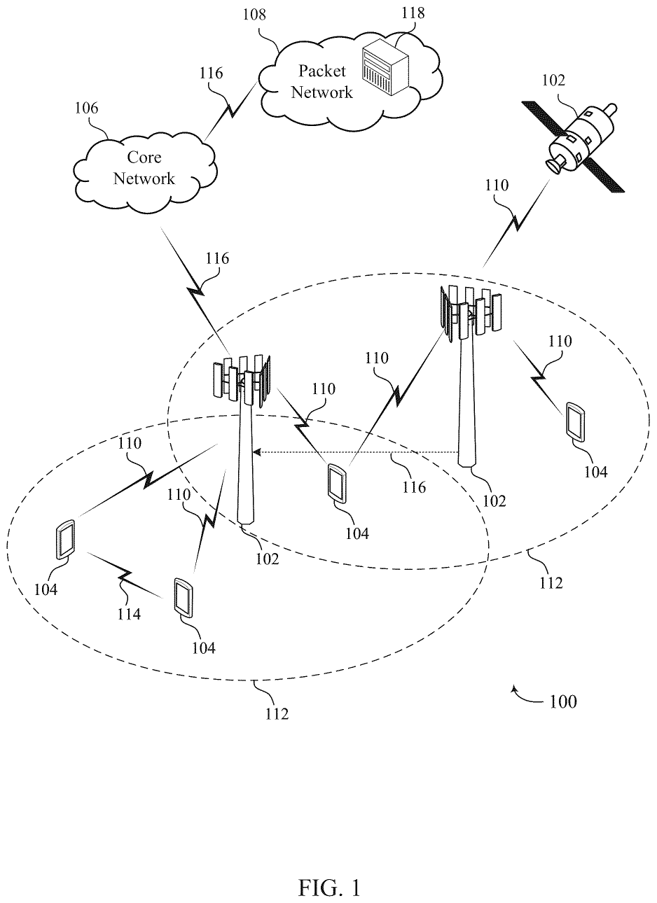

FIG. 1 illustrates an example of a wireless communications system 100 that supports COT structure sharing between UEs in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUsor RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. #Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHZ), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., (μ=2), which includes 60 kHz subcarrier spacing; and a fourth numerology (e.g., μ=3), which includes 120 kHz subcarrier spacing.

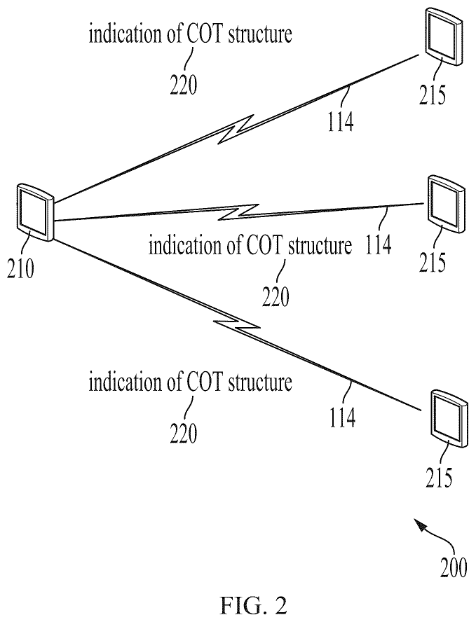

As described herein, a UE (e.g., an initiator or Tx UE) can share an indication of a COT structure to other UEs (e.g., receiver UEs or Rx UEs) over a sidelink. FIG. 2 illustrates an example of a diagram 200 that supports sidelink communication between UEs in an unlicensed spectrum accordance with aspects of the present disclosure.

A Tx UE 210 communicates with Rx UEs (e.g., a set of UEs) 215 over sidelinks 114. The Tx UE 210 transmits an indication of a COT structure 220 to the Rx UEs 220. For example, the Tx UE 210 shares the COT structure 220 with the RX UEs 215 in order to obtain feedback (Listen Before Talk, or LBT) from the Rx UEs 215, to obtain Physical Sidelink Shared Channel (PSSCH) transmissions from the Rx UEs 215, and so on, during a remaining channel occupancy.

As described herein, the indication of the COT structure 220 can inform the Rx UEs 215 as to how the TX UE 210 plans on utilizing the slot structure for contiguous transmission (e.g., transmission without any gaps or with reduced gaps). For example, the indication of the COT structure 220 can identify symbols that override any gap symbols and/or Physical Sidelink Feedback Channel (PSFCH) symbols of the slot structure of the sidelink 114.

For example, the resource pool for the sidelink includes gap (or guard) symbols and feedback symbols (e.g., Physical Sidelink Feedback Channel, or PSFCH, symbols), among other symbols, whose positioning and periodicity are fixed as part of a resource pool configuration. The COT structure 220 can override or modify such a configuration. This sidelink slot structure (the structure identified in Rel16) contains an automatic gain control (AGC) symbol at the beginning of the slot and a Physical Sidelink Control Channel (PSCCH) symbol followed by Physical Sidelink Shared Channel (PSSCH) symbols and a gap or guard symbol, which is placed to provide a switching time from transmission to reception.

The resource pool of the sidelink may be configured (or pre-configured) with one or two PSFCH symbol(s), using a PSFCH period of 1, 2, 4, 8 slots. Further, the slots where the PSFCH symbols occur can be configured with additional AGC symbols and/or gap symbols, for the reception of HARQ feedback from the receiver UEs 215.

In some cases, the indication of the COT structure 220 can signal a position of an extended cyclic prefix (CP-EXT) symbol to shorten any gap durations in the slot structure and/or a position of a dedicated PSFCH symbol to receive Hybrid Automatic Repeat Request (HARQ) feedback. Also, the indication of the COT structure 220 can identify when the Tx UE 210 is going to share the COT with the other UEs 220.

While the communications between the Tx UE 210 and the Rx UEs 215 are discussed in the context of a 5G or NR network, the technology described herein is also applicable to other wireless communications systems that are configured for or support sidelink communications over a PC5 interface between UEs.

As described herein, the Tx UE 210 is to perform contiguous transmission when utilizing the sidelink 114 in an unlicensed spectrum upon initiating channel occupancy. Further, any gap duration in the slot structure, used to perform LBT (category 2) by the receiver UEs 215 should be less than or equal to 16/25 microseconds.

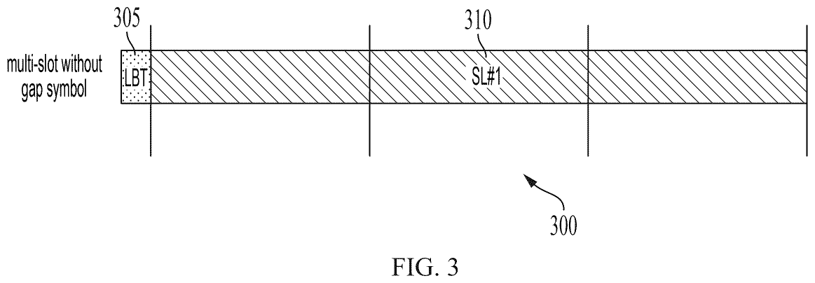

FIG. 3 illustrates an example of a diagram 300 that supports multi-slot contiguous transmission between UEs in accordance with aspects of the present disclosure. As depicted, slots 310 are transmitted from the Tx UE 210 in a burst or contiguous manner and in response to LBT 305 messages received from the Rx UEs 215.

Thus, to facilitate contiguous transmission in the sidelink 114, the Tx UE 210 can define a slot structure, represented by the indication of the COT structure 220, as a structure without gap symbols and/or with the addition of CP-Ext symbols that reduce gap durations in the slot structure (see, e.g., the slots 310 of FIG. 3).

A UE (e.g., the UE 104 or Tx UE 210) can transmit a COT structure indication (e.g., the indication 220) having one or more of the following parameters:
a parameter identifying or representing a remaining channel occupancy duration (e.g., represented as the number of slots), where a starting slot is a slot where the receiver UE (e.g., the UEs 215) detects the COT structure indictor and the remaining channel occupancy duration is based on the starting slot;
a parameter identifying or representing a Channel Access Priority Class (CAPC) value and/or priority value indicated by a higher layer, such as a logical channel (LCH) priority;
a parameter identifying or representing the overriding symbols (e.g., AGC symbols, gap symbols, PSFCH symbols), when the symbols are part of the resource pool and can occur in the channel occupancy initiated by the UE; and so on.

In some cases, the technology can enable contiguous sidelink transmission by overriding, using the overriding parameter, AGC symbols, gap symbols, and/or PSFCH symbols that are configured in the resource pool. In some cases, the overriding parameter is a bitmap containing an overriding bit for each slot. For example, when a COT duration is 8 ms and considering 15 KHz SCS, there are 8 slots, and the beginning of the bitmap indicates a beginning of a COT duration or first PSSCH transmission in a COT or slot where the COT structure indicator is detected.

The overriding bitmap, where each bit indicates a slot whether overriding of a symbol is possible (e.g., a bitmap containing “11111110”) overwrites the presence of AGC symbols, gap symbols, and/or PSFCH symbols, (pre) configured as part of the resource pool, in the first 7 slots with PSSCH symbols for contiguous transmission. If the last slot contains a gap symbol, then the gap symbol is not overwritten. However, if the last slot contains a PSFCH symbol, then both the gap symbol and the PSFCH symbol are not overwritten with PSSCH symbols.

In some cases, the default placement of the gap symbol and/or PSFCH symbol in each slot may not be configured as part of the resource pool configuration, and the COT structure provides the dedicated gap symbol and/or PSFCH symbol.

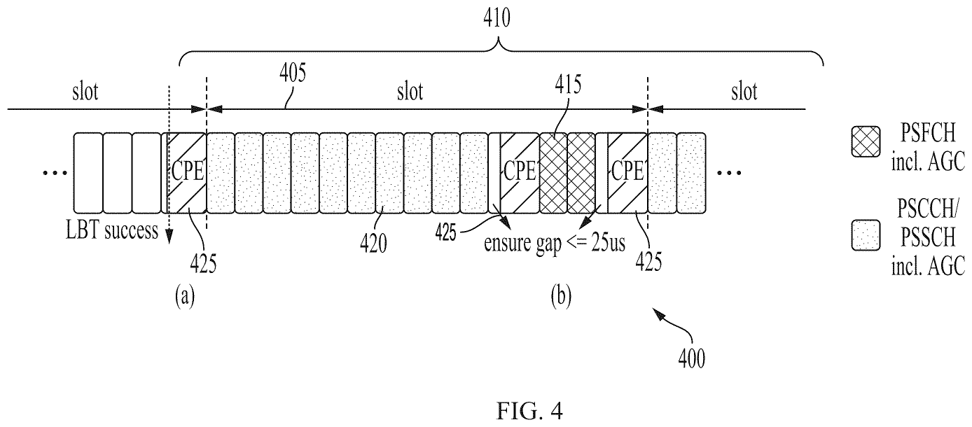

In some embodiments, the UE can configure dedicated CP-Ext symbols and/or gap symbols within the channel occupancy. The position of the CP-Ext symbols within the slot structure can be configured as part of the resource pool. FIG. 4 illustrates an example of a diagram 400 that supports a slot structure having a dedicated CP-Ext symbol in accordance with aspects of the present disclosure. A COT 410 has a slot structure 405 of multiple PSSCH/PSCCH slots 415 and PSFCH slots 420, including dedicated CP-EXT symbols 425 at the beginning of the slot structure 405 for performing Cat 2 LBT during COT sharing.

Further, there are dedicated CP-Ext symbols configured as part of the gap symbols in the middle of the slot structure 405, positioned before the configured PSFCH (or AGC) symbols, for the purpose of sidelink HARQ feedback. As shown, the PSFCH slot 420 contains an additional CP-Ext symbol 425 in the middle configured as part of the gap symbol, and an additional CP-Ext symbol 425 configured as part of the gap symbol to switching the time gap duration from transmission to reception.

In some cases, the position of the dedicated CP-Ext symbols 425 within the slot structure 405 is configured as part of the resource pool. However, the COT structure signaling can indicate the slot number for the dedicated CP-Ext symbol using a bitmap, as described herein. For example, a bitmap containing “00000011” indicates a presence of a CP-Ext symbol at the beginning of slot 7 and 8, and the beginning of the bitmap indicates the beginning of COT duration or first PSSCH transmission in a COT or slot, where the COT structure indicator may be detected. In some cases, such as when the slot contains PSFCH symbols, then the additional CP-Ext symbol can be positioned in the middle of the slot.

In some embodiments, the Tx UE 210, or the UE 104, can signal or otherwise indicate a dedicated PSFCH symbol to receive HARQ feedback or transmit HARQ feedback. In some cases, the position of the dedicated PSFCH symbol within the slot is configured as part of the resource pool. However, the signaling of the COT structure may indicate the slot number for the dedicated PSFCH symbol and the PSFCH format (e.g., one PSFCH format from multiple PSFCH formats configured in a resource pool using a bitmap).

In some cases, the UE transmits a COT sharing indicator along with the indication of the COT structure (e.g., indication 220) within an initiated channel occupancy. In some cases, the UE transmits the COT sharing indicator separately from the indication of the COT structure.

In some embodiments, the indication of the COT structure 220 can indicate the uplink (UL) slots or downlink (DL) slots for UL/DL transmission, since the UE can transmits via the UL or sidelink channels. For example, the UE can transmit a UL sharing indicator to the gNB to receive DL data from the gNB (or another network entity 102).

In some cases, the sidelink COT structure can indicate UL transmission in one or more UL slots within a UE initiated COT duration. The UE can perform sidelink transmission in the UL or sidelink slots.

In some cases, the resource pool bitmap may contain all ‘1’s to enable contiguous sidelink transmission (e.g., the resource pool occupies all physical slots within the COT).

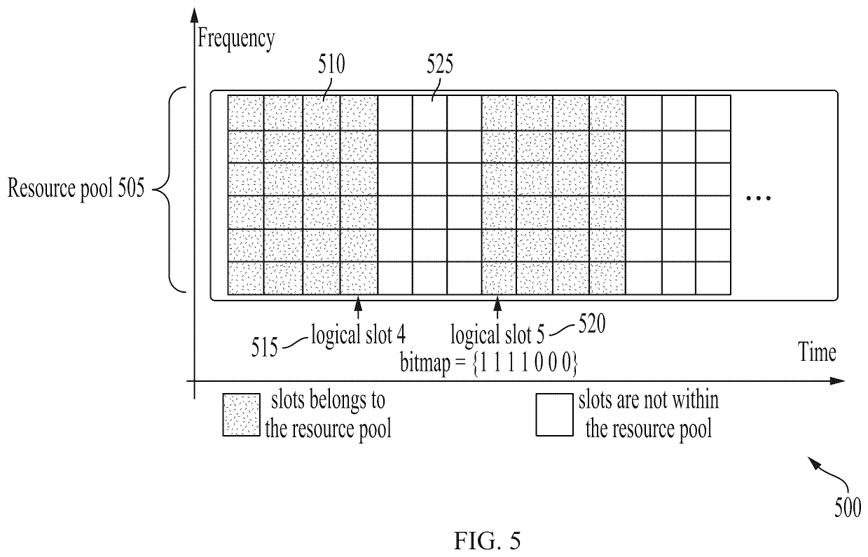

FIG. 5 illustrates an example of a diagram 500 that supports sidelink slots in a resource pool in accordance with aspects of the present disclosure. The diagram includes slots 510 that are part of a resource pool 505, and slots 525 that are not part of the resource pool 505.

In some cases, the bitmap for the resource pool 505 may contain “1111000,” as depicted in the diagram 500 of FIG. 5. Such a bitmap indicates that the COT duration can extend to the slots 525 that are not part of the resource pool 505. In such cases, the UE can perform sidelink transmission within the first four logical sidelink slots (e.g., logical slot 515) that are within the resource pool 505, but not at the logical slot 520. The COT structure may indicate whether there is any UL transmission in UL slots, which are not within the resource pool but within the COT duration. The COT may terminate at the resource pool boundary when there is no further uplink or sidelink transmission after the resource pool boundary.

In some embodiments, the UE can include an overriding additional PSCCH symbol within a slot at multiple starting points. For example, the starting points can be configured using one or more PSCCH/AGC symbols within a slot, so the UE can perform clear channel assessment procedures (e.g., Cat 4 LBT) at each of the starting points, until the LBT is successful.

Once the LBT is successful, the COT structure may explicitly override these multiple starting points (as they are no longer of use) within each slot, and the UE can contiguously transmit PSSCH (with a receiver UE no longer monitoring PSCCH in the middle of the slot and only monitoring the slot boundary).

In some cases, a table is configured using one or more parameters described herein, such as for different sub-carrier spacing and/or the positioning of CP-Ext symbols and PSFCH symbols within the COT duration. In some cases, a subset of table values can be configured for each resource pool, depending on the configured sub-carrier spacing in the resource pool. The UE can signal the table index in the 1^{st} SCI (sidelink control information) or 2^{nd} SCI. Table 1 below illustrates an example table configured with the parameters described herein:

TABLE 1

| | | | Over- | | | |
|---|---|---|---|---|---|---|
| | | | riding | | | |
| | | | symbols | | | |
| | | Remaining | (1 over- | Dedicated | COT | Dedicated |
| | | channel | riding and | CP-Ext | sharing | PSFCH |
| | | occupancy | 0 not- | symbols | indicator | symbol |
| Table | CAPC | duration | over- | (slot | (slot | (slot |
| index | value | (ms) | riding) | number) | number) | number) |
| 0 | 1 | 2 | 1 | 5 | 5 | 7 |

In some embodiments, the UE transmits the indication of the COT structure (e.g., indication 220) via the SCI or a MAC control element (MAC CE), or a combination. In some cases, the UE transmits the COT structure via the MAC VR and the COT sharing indicator using SCI. In some cases, the UE transmits the COT structure indicator using the 2^{nd} SCI and the COT sharing indicator using the 1^{st} SCI.

In some cases, the UE transmits the COT structure indication as part of the first transmission of the channel occupancy duration, or in the middle of the COT (or along with the COT sharing indicator). A processing timeline of the COT sharing indicator can be configured in a resource pool or configured by a semi-static signaling depending on the various SCS. In some cases, there is a minimum time gap configuration between the COT structure signaling transmission/reception and the transmission/reception of the COT sharing indicator, or the time slot where the channel occupancy is shared with the other UEs.

In some embodiments, the UE can transmit various parameters (e.g., location of CP-Ext symbols within a COT structure) together with the COT sharing indicator. Upon receiving the parameters and the COT sharing indicator, a receiver UE (e.g., Rx UE 215) can perform Cat 2 LBT in the CP-Ext symbols to transmit in the shared COT.

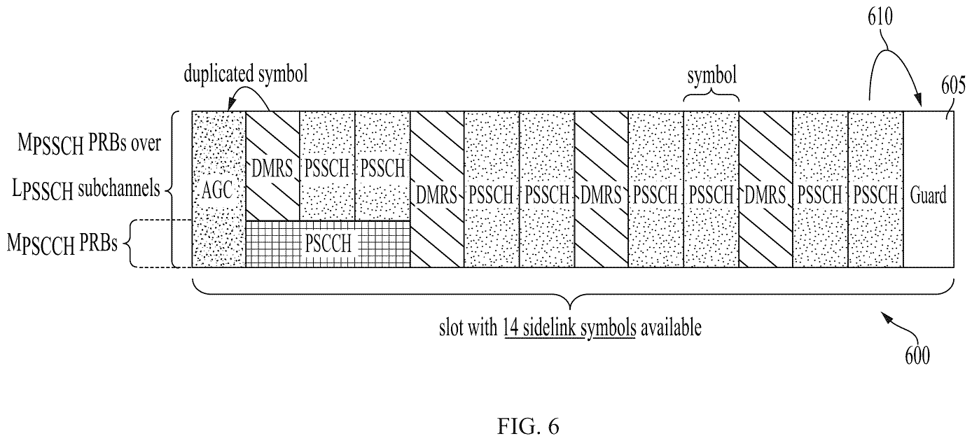

In some embodiments, the UE can repeat or introduce redundancy of gap symbols in the slot structure using the PSSCH transmission to perform contiguous transmission without any gap duration or PSFCH symbols. FIG. 6 illustrates an example of a diagram 600 that supports a slot structure having a repeated transmission symbol in accordance with aspects of the present disclosure.

As shown, a PSSCH symbol 610 is repeated at a gap or guard symbol 605 within the slot structure. Thus, the UE can indicate the COT structure by transmitting additional code bits carried by PSSCH symbols in the gap symbol and/or by PSFCH symbols.

Thus, in various embodiments, a UE facilitates contiguous transmission over a sidelink by defining a slot structure, represented by an indication of a COT structure, as a structure without gap symbols and/or with the addition of CP-Ext symbols that reduce gap durations in the slot structure. The UE (e.g., Tx UE 210) shares the COT structure with a set of UEs (e.g., Rx UEs 215), to ensure contiguous transmission over the sidelink, such as within an unlicensed spectrum.

In some embodiments, a UE acting as a receiver of sidelink communications (e.g., the Rx UE 215) can exhibit various behaviors based on whether COT structure sharing has occurred. The receiver UE behavior can be different and based on receipt of COT structure signaling from a transmitting UE (e.g., the Tx UE 210). The receiver UE can determine whether to interpret sidelink reception from a UE that transmitted the COT structure indication.

For example, the receiver UE, after receiving the COT structure indication (e.g., the indication 220), can interpret one or more parameters in the COT structure, determine the reference slot duration and the remaining COT duration, and execute the placement of one or more parameters in the slot structure identified in the COT structure indication.

Thus, the receiver UE operates in a certain manner when the UE does not receive COT structure signaling (e.g., does not receive the indication of the COT structure 220). For example, the receiver UE may assume that the gap symbols and the PSFCH symbols that are configured as part of the resource pool are interpreted as switching gap duration and HARQ feedback transmission in the PSFCH symbol. While the transmitter UE may repeat symbols and/or include extra redundancy in the gap symbol/AGC symbol/PSFCH using the PSSCH transmission to perform contiguous transmission without any gap duration, the receiver UE may not decode the data in the gap symbol/AGC symbol/PSFCH without any indication or sharing of the COT structure.

In some cases, the receiver UE may perform the Cat 2 LBT before the PSFCH symbol and/or may transmit HARQ feedback in a PSFCH symbol using short control signaling exemption (e.g., where any transmission performed under the short control signaling exemption should not exceed 5 ms duration in a 100 ms window). The receiver UE may perform Cat 4 LBT before the PSFCH symbol to check whether there is any transmission by the Tx UE, and if the LBT succeeds then the receiver transmits the PSFCH symbol (or otherwise does not transmit the PSFCH symbol).

When the Tx UE does not indicate HARQ enable in the SCI in any of the previous transmissions prior to the PSFCH symbol, then the receiver UE may not perform Cat 2 LBT in the PSFCH symbol nor transmit using the short control signal exemption, because it does not assume that the Tx UE has overridden the PSFCH symbol with the PSSCH transmissions.

In some embodiments, when the receiver UE has received a COT structure indication, the receiver UE may execute the overriding of gap symbols with the PSSCH symbol and the placement of the dedicated gap symbol, CP-Ext symbol and/or PSFCH symbol as specified in the COT structure indication.

In some cases, the COT structure indication may be a bitmap where each bit indicates a slot and the placement of dedicated gap symbols, CP-Ext symbol, and/or PSFCH symbols within the slot may be provided by the resource pool configuration. The starting slot for the bitmap indicates a reference slot, where the COT structure indication is detected. In some cases, the starting slot may be defined at the beginning of the COT duration or at the first slot where PSSCH is transmitted after the COT is successfully initiated or transmitted.

In some cases, the receiver UE, after detecting the COT structure indication, may successfully decode the additional code bits carried by PSSCH in the gap symbol and PSFCH symbol.

In some cases, the receiver UE determines the reference starting slot, which is the reference slot that indicates the COT structure indication is successfully received to execute the placement of dedicated symbols, overriding symbols, COT sharing indicators and/or the remaining COT duration.

In some embodiments, there can be switching between multiple starting positions and a reduced starting position within the COT. For example, multiple starting points can be configured using multiple PSCCH/AGC symbols within a slot (e.g., at the beginning of a slot symbol #0 and the middle of a slot symbol #7). A receiver UE, based on the multiple symbols, can perform clear channel assessment procedure (e.g., Cat 4 LBT) at one or more of the starting points within the slot to obtain more LBT occasions. For slots containing a PSFCH resource, the starting positions are configured at the beginning of the slot at symbol #0 for AGC/PSCCH transmission. Before the AGC symbol for PSFCH transmission, the starting position at the middle of the slot at symbol #7 may not be configured when the slot contains the PSFCH resource.

Once the LBT is successful, the multiple starting points may not be useful until the end of the remaining channel occupancy duration indicated by the Tx UE. Thus, there are various ways to switch between the multiple starting positions and the reduced starting position within the COT. After the COT terminates, the UEs may switch back to multiple starting positions to perform LBT or listen to other UE transmissions. The following switching options include:
The COT structure indication may explicitly override these multiple starting points within each slot so that the UE may contiguously transmit PSSCH. The receiver UE may not monitor the PSCCH in the middle of the slot and may monitor only at the beginning of the slot boundary;
The COT structure indication may explicitly override these multiple starting points within each slot so that the UE may contiguously transmit PSSCH. The receiver UE may not monitor PSCCH in the middle of the slot and also at the beginning of the slot boundary (see FIG. 2);
The COT structure indication may indicate the remaining channel occupancy duration in the SCI transmitted by the Tx UE. The Rx UE may not search for multiple AGC and PSCCH candidates in slots after the first slot within the COT. Once the COT terminates, the UEs (e.g., the Tx UE and the Rx UE may sense from energy detection) may fall back to the multiple starting points (e.g., receiving multiple AGC and PSCCH candidates within a slot in every slot); and various combinations.

The COT structure indication may indicate the remaining channel occupancy duration in the SCI transmitted by the Tx UE. The Rx UE may not search for multiple AGC and PSCCH candidates in slots after the first slot within the COT. The UE may terminate the COT earlier than the previously announced remaining channel occupancy duration and, in such cases, the UE may transmit the COT termination indicator in the SCI scheduling last TB in the COT. The Rx UE, after detecting the COT termination indicator, may fall back to the multiple starting points (e.g., receiving multiple AGC and PSCCH candidates within a slot in every slot). The COT termination indicator may be a one-bit field carried in the 1^{st} SCI or 2^{nd} SCI. For example, setting the bit to ‘1’ in the SCI indicates that COT terminates at the last PSSCH symbol in that slot.

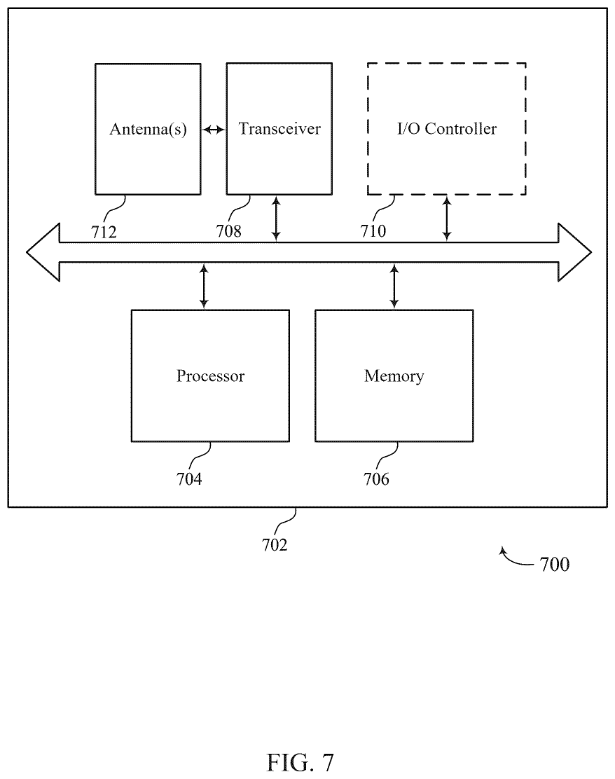

FIG. 7 illustrates an example of a block diagram 700 of a device 702 that supports COT structure sharing between UEs in accordance with aspects of the present disclosure. The device 702 may be an example of a UE 104 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. processor 704 may be configured as or otherwise support a means for receiving a slot structure configuration for wireless communication with a set of UEs over a sidelink and transmitting, to the set of UEs over the sidelink, an indication of a channel occupancy time (COT) structure for a contiguous transmission over the sidelink.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor M06. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

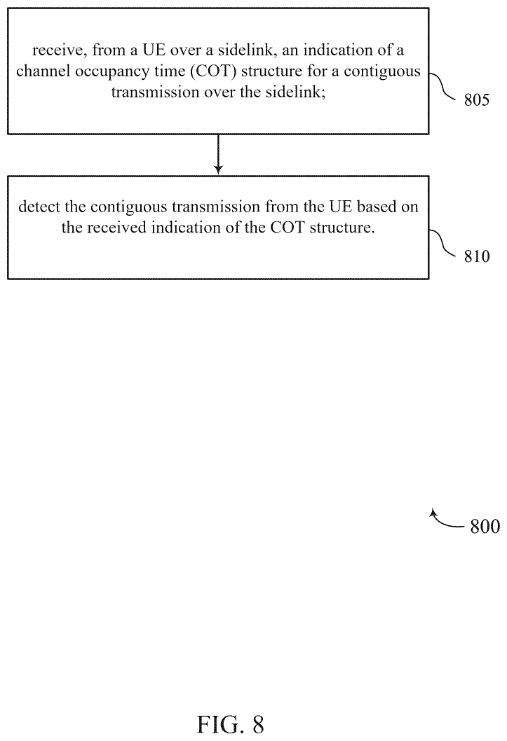

FIG. 8 illustrates a flowchart of a method 800 that supports COT structure sharing between UEs in accordance with aspects of the present disclosure. The operations of the method 800 may be implemented by a device or its components as described herein. For example, the operations of the method 800 may be performed by a UE 104 or UEs 215 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 805, the method may include receiving, from a UE over a sidelink, an indication of a COT structure for a contiguous transmission over the sidelink. The operations of 805 may be performed in accordance with examples as described herein. In some implementations, aspects of the operations of 805 may be performed by a device as described with reference to FIG. 1.

At 810, the method may include detecting the contiguous transmission from the UE based on the received indication of the COT structure. The operations of 810 may be performed in accordance with examples as described herein. In some implementations, aspects of the operations of 810 may be performed by a device as described with reference to FIG. 1.

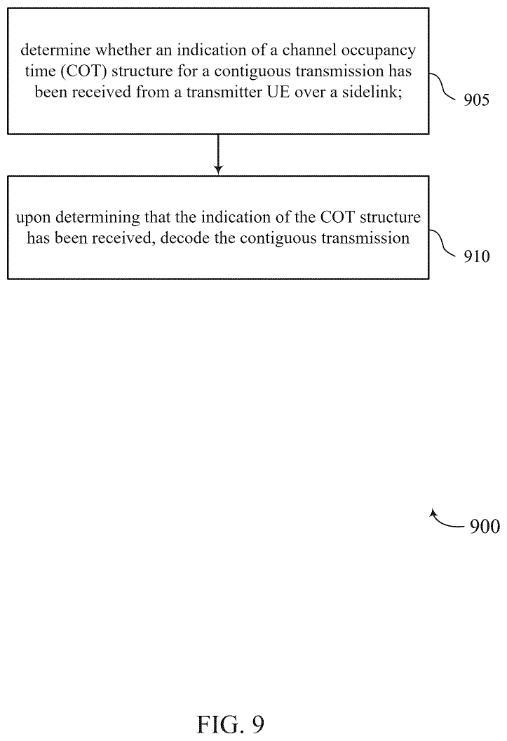

FIG. 9 illustrates a flowchart of a method 900 that supports COT structure detection by a receiver UE in accordance with aspects of the present disclosure. The operations of the method 900 may be implemented by a device or its components as described herein. For example, the operations of the method 900 may be performed by a UE 104 or UEs 215 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 905, the method may include determining whether an indication of a channel occupancy time (COT) structure for a contiguous transmission has been received from a transmitter UE over a sidelink. The operations of 905 may be performed in accordance with examples as described herein. In some implementations, aspects of the operations of 805 may be performed by a device as described with reference to FIG. 1.

At 910, the method may include upon determining that the indication of the COT structure has been received, decoding the contiguous transmission. The operations of 910 may be performed in accordance with examples as described herein. In some implementations, aspects of the operations of 910 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive, from a UE over a sidelink, an indication of a channel occupancy time (COT) structure for a contiguous transmission over the sidelink; and
detect the contiguous transmission from the UE based on the received indication of the COT structure.

2. The UE of claim 1, wherein the indication of the COT structure includes an indication of a location of an extended cyclic prefix (CP-Ext) symbol or a Physical Sidelink Feedback Channel (PSFCH) symbol in the COT structure.

3. The UE of claim 1, wherein the contiguous transmission from the UE includes a contiguous Physical Sidelink Shared Channel (PSSCH) transmission in a gap symbol of the COT structure.

4. The UE of claim 1, wherein the contiguous transmission includes a PSSCH transmission, the processor is further configured to decode extra code bits in a gap symbol, a PSFCH symbol or an automatic gain control (AGC) symbol of the PSSCH transmission.

5. The UE of claim 1, wherein the at least one processor is further configured to cause the UE to:
detect the indication of the COT structure; and
determine a reference starting slot from the detected COT structure.

6. The UE of claim 1, wherein the sidelink is part of an unlicensed spectrum.

7. The UE of claim 1, wherein the contiguous transmission over the sidelink includes transmitting sidelink control information (SCI) or sidelink data over two or more slots contiguous in a time domain.

8. The UE of claim 1, wherein the at least one processor is configured to cause the UE to receive the indication of the COT structure during a first transmission of the COT, during a middle period of the COT, or along with reception of a COT sharing indicator.

9. The UE of claim 1, wherein the indication of the COT structure includes a bitmap configuration of symbols that override PSFCH symbols and guard symbols within slots of the slot structure of the sidelink with PSSCH symbols.

10. A method performed by a user equipment (UE), the method comprising:
receiving, from a UE over a sidelink, an indication of a channel occupancy time (COT) structure for a contiguous transmission over the sidelink; and
detecting the contiguous transmission from the UE based on the received indication of the COT structure.

11. The method of claim 10, wherein the indication of the COT structure includes an indication of a location of an extended cyclic prefix (CP-Ext) symbol or a Physical Sidelink Feedback Channel (PSFCH) symbol in the COT structure.

12. The method of claim 10, wherein the contiguous transmission from the UE includes a contiguous Physical Sidelink Shared Channel (PSSCH) transmission in a gap symbol of the COT structure.

13. The method of claim 10, wherein the contiguous transmission includes a PSSCH transmission, the method further comprising decoding extra code bits in a gap symbol, a PSFCH symbol or an automatic gain control (AGC) symbol of the PSSCH transmission.

14. The method of claim 10, further comprising:
determining a reference starting slot from the detected COT structure.

15. The method of claim 10, wherein the sidelink is part of an unlicensed spectrum.

16. The method of claim 10, wherein the contiguous transmission over the sidelink includes transmitting sidelink control information (SCI) or sidelink data over two or more slots contiguous in a time domain.

17. The method of claim 10, wherein the UE receives the indication of the COT structure during a first transmission of the COT, during a middle period of the COT, or along with reception of a COT sharing indicator.

18. A processor for wireless communication, comprising:
at least one controller coupled with at least one memory and configured to cause the processor to:
receive, from a UE over a sidelink, an indication of a channel occupancy time (COT) structure for a contiguous transmission over the sidelink; and
detect the contiguous transmission from the UE based on the received indication of the COT structure.

19. The processor of claim 18, wherein the indication of the COT structure includes an indication of a location of an extended cyclic prefix (CP-Ext) symbol or a Physical Sidelink Feedback Channel (PSFCH) symbol in the COT structure.

20. A user equipment (UE) for wireless communication, comprising:
at least one memory; and
at least one processor coupled with the at least one memory and configured to cause the UE to:
determine whether an indication of a channel occupancy time (COT) structure for a contiguous transmission has been received from a transmitter UE over a sidelink; and
upon determining that the indication of the COT structure has been received, decode the contiguous transmission.
